(19) United States
(12) Patent Application Publication
(10) Pub. No.: US 2009/0089202 A1
(43) Pub. Date: Apr. 2, 2009

(54) ALGORITHMIC ORDER MANAGEMENT TOOL FOR TRADING FINANCIAL INSTRUMENTS

(75) Inventor: Matthew ROWLEY, Red Bank, NJ (US)

Correspondence Address: SUGHRUE MION, PLLC, 2100 PENNSYLVANIA AVENUE, N.W., SUITE 800, WASHINGTON, DC, 20037, US

(73) Assignee: FIDESSA CORPORATION, New York, NY (US)

(21) Appl. No.: 12/239,355

(22) Filed: Sep. 26, 2008

Related U.S. Application Data
(60) Provisional application No. 60/975,981, filed on Sep. 28, 2007.

(51) Int. Cl. G06Q 40/00

(52) U.S. Cl. 705/37

(57) ABSTRACT

A method and an apparatus which provides a programmatic framework that can be used to rapidly build and deploy custom trading algorithms that are used for automated algorithmic handling of orders in the context of electronic trading of financial instruments are provided. The algorithmic trading framework can be fully integrated with an existing order management system.

### CROSS-REFERENCE TO RELATED APPLICATIONS

This application claims priority from U.S. Provisional Application No. 60/975,981, filed on Sep. 29, 2007, the entire disclosure of which is incorporated herein by reference.

### FIELD OF INVENTION

Systems and methods consistent with the present invention generally relate to electronic trading of financial instruments and more particularly, to algorithmic order execution in the context of such electronic trading of financial instruments. The financial instruments can be traded in a market that systematically combines buyers and sellers who place orders to buy and sell (i.e., bids and offers) at different prices for different quantities for each instrument.

### BACKGROUND OF THE INVENTION

Electronic trading of financial instruments in various market exchanges throughout the world has become prevalent and now accounts for the majority of trading activity. Traders anywhere in the world equipped with their personal computers can communicate with a host market center to determine the availability of financial instruments, to place orders, and to confirm orders.

Traders, whether or not they are affiliated with registered Broker-dealers, engaged in electronic trading typically utilize software products that provide the traders with specialized graphical user interfaces, through which the user can obtain market price data and can enter and route, their orders. With respect to traders employed by Broker-dealers, these orders can represent either their own proprietary interest or be received, entered and routed on behalf of customers. In addition, broker-dealers can execute customer orders out of proprietary accounts. The overall ease of use and quality of features available to the traders depends on the individual type of electronic trading application that is used.

Because financial instruments are, for the most part, traded electronically, the speed at which a trader can place an order is of utmost importance. That is, it is critical that each trader engaged in electronic trading be able to decide as quickly as possible whether to wait, fill, enter or route an order based on the information made available to them through the electronic trading application, and then, as quickly as possible, effect such a transaction such that an order is filled, entered or routed. As such, over time, a trader's failure to competitively enter or fill an order in a timely manner can potentially result in significant monetary losses or the opportunity cost of failing to obtain monetary gains. Therefore, it would be beneficial to be able to automate the entry and execution of orders because automated entry and execution of orders would increase the trader's ability to act quickly.

Further, traders, including broker-dealers, must be able to process and absorb a large amount of available market information criteria when engaged in trading because the trading of financial instruments is a fast-paced, fluid environment where price, quantity, and other market information criteria constantly fluctuate within a very short period of time. Therefore, the accuracy and competency with which an individual trader engages in electronic trading is also of paramount importance. However, existing electronic trading platforms require manual execution and entry of orders. There is an inherent risk that the trader will introduce errors during this manual execution and entry of orders.

Furthermore, orders that require numerous repetitive actions by the trader engaged in electronic trading are more suitable for automation than other orders. If these orders can be placed and executed automatically, based on a set of algorithms developed by a trader and built to mimic a particular behavior of a trader, some of the deficiencies with existing systems discussed above could be overcome. Moreover, the automatic placement and execution of orders frees up the trader to work on more complex tasks that are difficult to automate.

### SUMMARY OF THE INVENTION

According to an aspect of the invention, orders can be placed and executed automatically. Such automated algorithmic execution of orders may overcome the above-mentioned deficiencies, as orders are filled and executed speedily and accurately based on an algorithm built to mimic a particular behavior of a trader.

It is an aspect of the present invention to provide a method and an apparatus which provides a programmatic framework that can be used to rapidly build and deploy trading algorithms that are used for automated algorithmic execution of orders in the context of electronic trading of financial instruments.

It is an aspect of the present invention to provide an algorithmic trading framework which fully integrates with an existing electronic order management system such as the FIDESSA OMAR Platform.

It is another aspect of the present invention to provide a high-level application programming interface (API) that allows rapid building and deployment of trading algorithms without the need for trading platform specific knowledge. This high-level API could be, for example, Java, C, C++, etc.

It is yet another aspect of the present invention to run algorithms either inside or outside of the electronic trading platform.

It is yet another aspect of the present invention to utilize extensible markup language (XML) based parameter specification for an automatic generation of dynamic user dialogs.

It is yet another aspect of the present invention to provide a lightweight and scalable architectural framework that can be upgraded independently of the order management system with which it is integrated.

It is yet another aspect of the present invention to utilize pre-built models, a test harness and example code to aid development and testing of algorithms to be used in the algorithmic trading of orders.

In yet another aspect of the present invention, a computer program product embodied on a computer-readable medium for efficiently and intuitively providing a programmatic framework that can be used to rapidly build and deploy custom trading algorithms that are used for automated algorithmic execution of orders in the context of electronic trading of financial instruments is also provided.

### BRIEF DESCRIPTION OF THE DRAWINGS

The above and other features and advantages of the present invention will become more apparent by describing in detail the following exemplary embodiments thereof with reference to the attached drawings in which:

FIG. 1 is an exemplary illustration of an algorithm order management (AOM) tool according to an exemplary embodiment;

FIG. 2 shows a detailed view of the AOM tool of an exemplary embodiment used with a server;

FIG. 3 shows a high level view of an illustrative and exemplary embodiment of the AOM tool integrated into an existing trading platform;

FIG. 4 is an exemplary illustration of a trader's user screen;

FIG. 5 is an exemplary illustration of a service strategies interface within the user screen;

FIG. 6 is an exemplary illustration of a higher-level Java API for the developer developing an algorithm, according to an exemplary embodiment of the present invention;

FIG. 7 is an exemplary depiction of a dialog that the front end device automatically constructs from reading an XML based configuration file;

FIG. 8 is an exemplary illustration of a test harness utilized in the exemplary embodiment of the present invention; and

FIG. 9 is an illustration of a simulator development environment within the testing models according to an exemplary embodiment of the present invention.

### DETAILED DESCRIPTION OF THE EXEMPLARY EMBODIMENTS

In the exemplary embodiments of the present invention, an algorithmic order management (AOM) tool is integrated into an order management system and is implemented on a server network. The user terminal communicates with the market data server to receive various market information including prices and volumes of the different bids and offers.

An exemplary embodiment of the AOM tool is presented to the user as part of an internal order management execution service, such as a FIDESSA Order Management and Routing (OMAR) execution service. The internal order management execution service manages all orders and can automatically route them to various execution services. An execution service is an abstract concept that represents a destination where an order may be filled, for example, traders, electronic communication networks (ECNs), the New York Stock Exchange (NYSE), or internal services that provide automatic filling of customer orders by proprietary executions or matching.

The algorithms provided by the AOM tool are presented to a user (e.g., a trader) who is filling an order to buy or sell a financial instrument. The AOM tool allows a developer to create simple flexible algorithms via a high level interface. Moreover, the AOM tool allows users to choose appropriate parameters for executing a trade based on these algorithms.

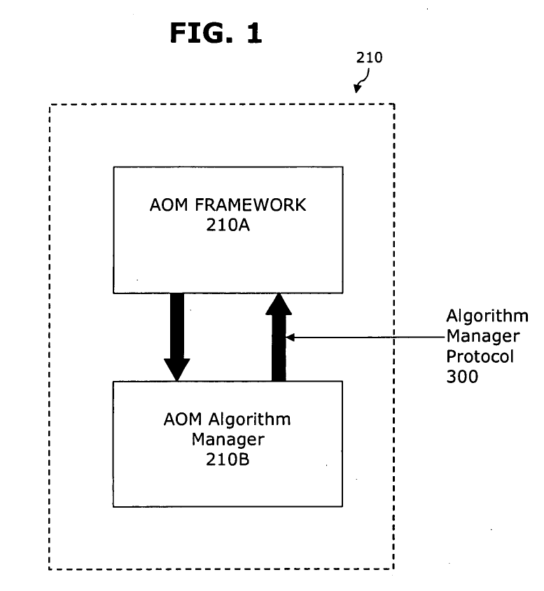

FIG. 1 is a simplified drawing showing the AOM tool 210 according to an exemplary embodiment of the invention. The AOM tool 210 includes bi-directional communication between one or more AOM framework 210A and an AOM manager 210B via an algorithm manager protocol 300. That is, trading algorithms, which are driven by a plurality of parameters, are developed in the AOM framework. The AOM manager 210B calls the trading algorithms into an order management system through the algorithm manager protocol 300. The trading algorithms can then be associated with an automated order.

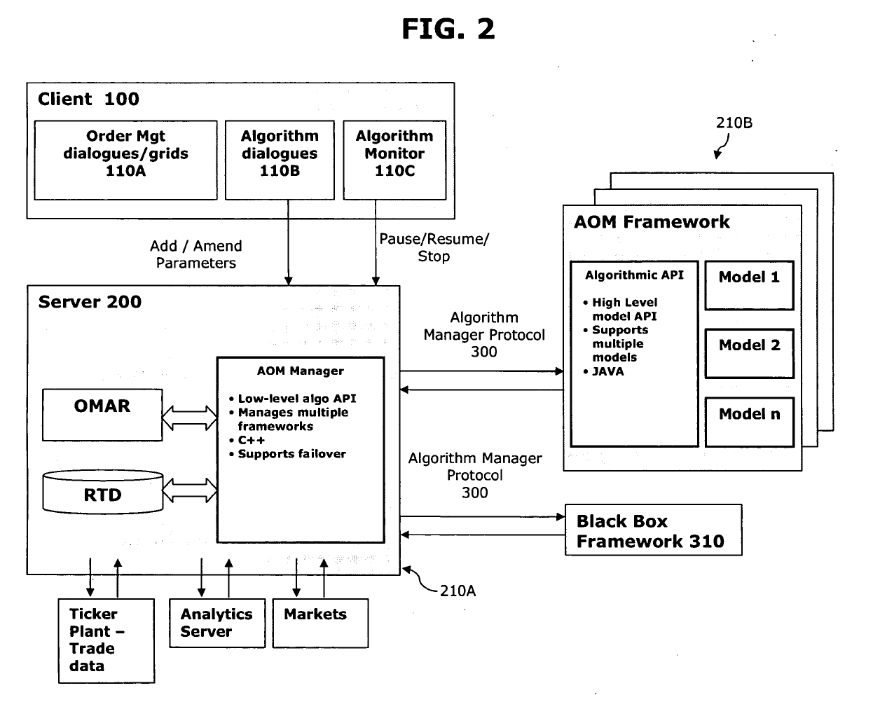

FIG. 2 shows more details and the environment of the AOM tool. As shown in FIG. 2, the AOM framework 210B can be a high level API (e.g., Java) that can be used by developers to create algorithmically driven trading models (e.g., Model 1, Model 2, Model n, etc.). An exemplary trading model might be one that would provide the trader with the ability to automatically trade a large order by dividing the large order into many small orders that are traded over the course of the trading day. The AOM framework 210B may also provide inbuilt functions to a developer to assist in developing the final trading model. Alternatively, a developer may use the inbuilt functions and supplement these functions with implementation specific code to make a complete trading model that can communicate at a low level with the AOM manager 210A.

The AOM manager 210A is a more complex, lower level API. The AOM manager 210A that can manage one or more AOM frameworks 210B. The AOM manager 210A receives the orders to be traded and supplies the trading instructions to the AOM framework 210B, which instantiates an object that interacts with the other functions present in the trading server.

The AOM tool allows orders to be executed based on algorithm-specific parameters that are supplied by the user at the time when orders are routed or split to the order management execution service. These user supplied parameters are used by a trading algorithm to influence the trading behavior of a model according to the user's trading objective. For example, the AOM tool 210 of the present exemplary embodiment can fill orders by splitting child orders to the market on a regular basis, such as every X minutes. In this case, X would be a trader-supplied parameter, e.g. X=1 minute. As a result, the AOM tool 210 can automatically split a large order into smaller child orders and automatically route these orders to the marketplace displaying the best prices against which executions will be effected. The objective of this trading procedure is to reduce the impact of the overall order on the market.

Referring again to FIG. 2, the AOM manager 210A of the exemplary embodiment is a component of the server 200 that manages multiple AOM frameworks 210B. Each AOM framework 210B is a high level API in which multiple trading models 1, 2, n, etc. can be created, each trading model intended to meet one of various trading objectives. Communication between the AOM manager 210A and the AOM framework 210B is provided by the algorithm manager protocol 300. Accordingly, trading algorithms can be easily created by selecting or extending an existing framework model that has already been created by a developer.

Moreover, new framework models can be easily created by a developer using the high level API rather than the more cumbersome, lower level API of the AOM manager 210A. However, if a developer does not wish to use the AOM framework 210B to develop additional framework models, the developer could provide their own framework, which is referred to herein as a “Black Box” framework 310, which is also written according to the algorithmic manager protocol 300.

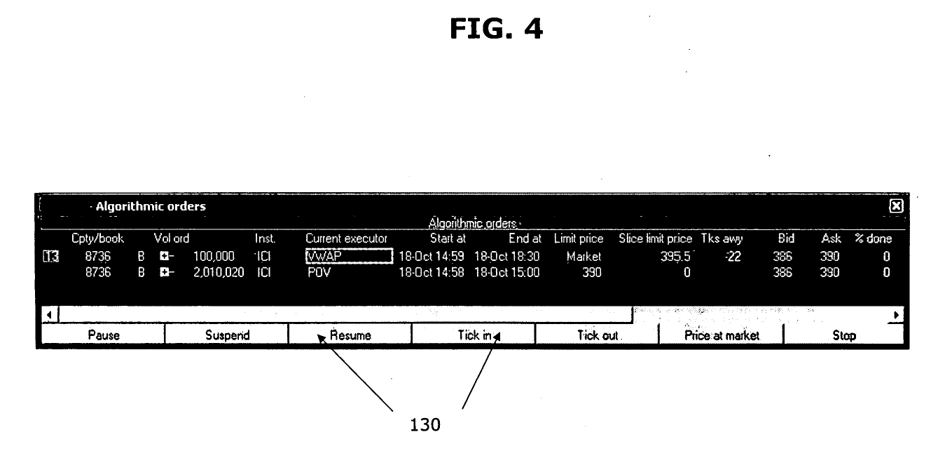

As is also discussed above, in this exemplary embodiment, the AOM tool 210 is controlled via a client 100, which include various grids/dialogs, which are provided on the user's computer screen. According to this exemplary embodiment, the client 100 allows the user to view the parameters of a selected framework model 210B and to modify values for the parameters via order management dialogues/grids 110A and to control the handling of orders via an algorithm dialogue 110B. Moreover, the user can control the trading via an algorithm monitor 110C. For example, the user can pause, resume, or stop the trading of an algorithm by clicking on buttons 130, as shown in the algorithm monitor 110C of FIG. 4, which is discussed in detail later.

A user (i.e., a trader) can easily modify parameters of a selected trading algorithm by selecting a specific order management dialog/grid 110A, which includes specific parameters, from among various available order management dialogs/grids 110. The user can enter or modify values for each of the algorithm parameters.

Moreover, as shown in FIG. 2, the user can amend an order, for example, adding or amending parameters of a trading algorithm, by selecting an algorithm dialogue 110B. The client 100 then communicates with the AOM tool 210 through an API call. The AOM manager 210A of the server 200 communicates with an appropriate AOM framework 210B in order to provide the appropriate trading algorithm, which interacts with the server 200 via the AOM manager 210A. The server 200 then handles the order by communicating with various execution services, such as exchanges or major electronic communication networks (ECNs), and electronically routing the order.

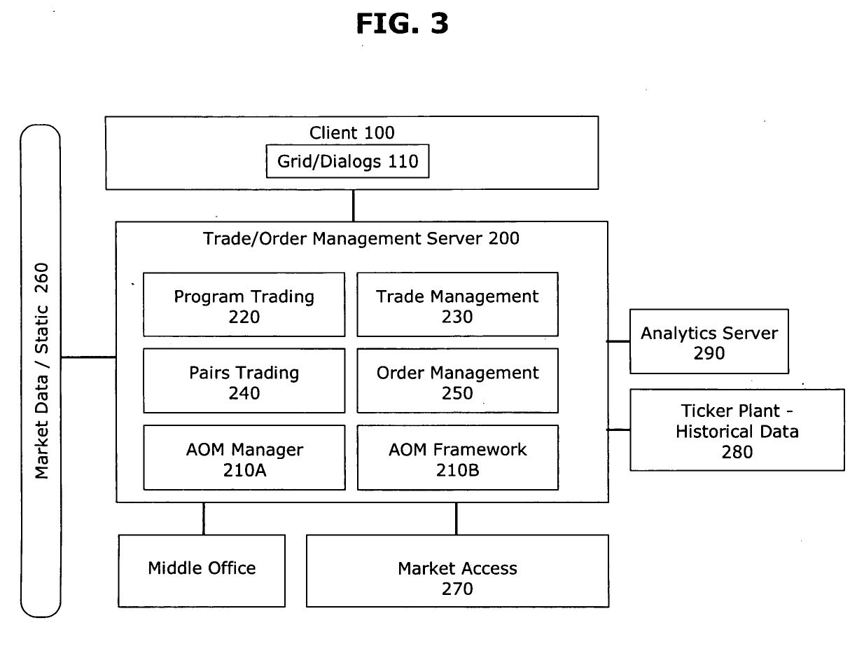

FIG. 3 shows a high level view of another exemplary embodiment of an AOM tool, which is integrated into an existing trading platform. According to this exemplary embodiment, the AOM manager 210A and the AOM framework 210B are both provided in a trade/order management server 200. The server 200 is the server for the existing trading platform and includes units that perform many existing functions. These functions can include managing all orders and automatically routing the orders to the various execution services.

In this example, the units of the server 200 that provide existing functions are a program trading unit 220, a trade management unit 230, a pairs trading unit 240, and an order management unit 250. However, the invention is not limited to these functions, which are provided in order to describe the environment in which the invention is used. The program trading unit 220 allows trading of multiple orders together in a coordinated fashion. The trade management unit 230 provides management services, such as a counting mechanism for keeping track of the firm's inventory positions and keeping track of fills against the orders being traded. The pairs trading unit 240 allows buying and selling of related stocks. The order management unit 250 manages investor orders, such as institutional orders (i.e., large orders traded by institutional investors like Mutual Funds, etc).

In this exemplary embodiment, the server 200 also houses at least part of the AOM tool 210. However the invention is not limited to the code for the AOM tool 210 being stored on the server 200. For example, the AOM tool 210 could be provided on a separate personal computer or a distributed network so that information is transferred between the AOM tool 210 and the server 200. Moreover, in this exemplary embodiment, the existing trading platform also includes a market/data static unit 260 for providing the market data to the platform, a market access unit 270 for accessing the markets, a ticker plant 280, which stores market data generic to the industry, and an analytics server 290, which provides statistical analysis based on historical and real-time data. The invention is not limited to these features and various functions could be added or deleted from the trading platform and server depicted in FIG. 3 without departing from the invention.

FIG. 4 is an exemplary illustration of the algorithm monitor 110C of the client 100 (i.e., user screen) depicted in FIG. 2 and discussed briefly above. The algorithm monitor 110C displays orders traded within the engine (e.g., trader, group, all), and allows the user to control execution of the orders. The “Pause” function suspends algorithmic trading of the selected orders but leaves any child orders of the selected orders on the market to which they were transmitted. The “Pull and Pause” function (not shown) suspends algorithmic trading of the selected orders, while pulling any child orders of the selected orders are pulled from the market. The “Resume” function restarts algorithmic trading for the selected orders. The “Stop” function stops algorithmic trading for the selected orders while pulling any child orders of the selected orders from the market. The “Tick In” function amends the price of any child orders of the selected orders that are on the market so that the price of a buy order is amended up and the price of a sell order is amended down. If a selected order is an algorithmic order, the price of the order's active slices (i.e., child orders of an algorithmic order) are amended, and, if the selected order is a slice of the order, then only the price of the selected slice is amended. Likewise, the “Tick Out” function amends the price of any child orders of the selected orders that are on the market so that the price of a buy order is amended down and the price of a sell order is amended up. Again, if a selected order is an algorithmic order, the price of all the order's active slices are amended, and, if the selected order is a slice of the order, then only the price of that slice is amended. The “Price at Market” function amends the price of any child orders of the selected orders that are on the market so that the price of a buy order is amended to the market's offer price, while the price of a sell order is amended to the market's bid price. Again, if a selected order is an algorithmic order, then the price of all of the order's active slices are amended, and, if the selected order is a only a slice, then only the price of that slice is amended.

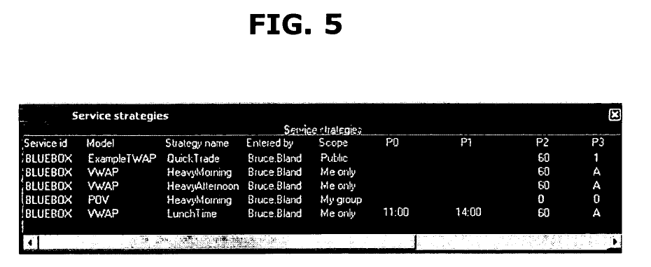

FIG. 5 is an exemplary illustration of a service strategies interface within the trader's user screen 100, depicted in FIG. 2. This interface allows users to view stored parameter settings for specific algorithmic models as service strategies. Each of the stored service strategies may correspond to a trading action that is repeated or performed regularly. As shown in FIG. 5, the scope of the parameters for each strategy may be set as public, group, or “trader only,” the scope specifying the users that are authorized to view that service strategy.

Next, the development of specific trading algorithms will be discussed.

### Developing Algorithms

As shown in FIGS. 2 and 3, the AOM tool 210 of the exemplary embodiments implements a self-describing, service-based transport, built on top of TCP/IP (‘OpenAccess’) and API that provides the trading algorithms with details of orders, events, and market data from the existing trading platform. As such, the AOM tool 210 allows algorithms to perform actions within the existing trading platform.

Algorithms may be developed directly using the algorithmic manager protocol 300 or may be developed with an AOM framework 210B, as shown in FIG. 2. In the embodiment of FIG. 2, the algorithmic model framework 210B communicates with the existing server 200 using the algorithm manager protocol 300. The AOM framework 210A also provides a higher-level Java API that allows the algorithm developer to develop trading algorithms using the highly detailed OpenAccess protocol and message specification. By connecting additional frameworks 210B to the AOM manager 210A at the API level, the system is highly-scalable and is independent of the trading platform version. Thus, the trading platform itself can be modified without any substantive effects on the final trading models 1, 2, n, etc. created in the AOM framework 210B. Conversely, models created against the AOM framework 210B may be upgraded without requiring an upgrade to the core order management system.

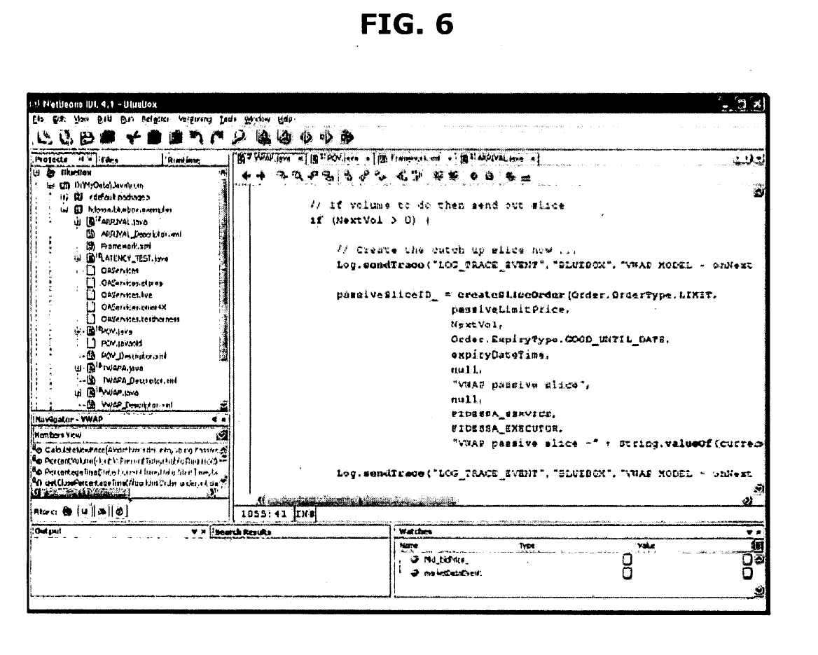

FIG. 6 exemplarily shows a higher-level Java API for a developer who is developing an algorithm using the AOM tool of the exemplary embodiments. Developers can utilize such higher-level Java API within the AOM framework 210B to develop various algorithmic models. Within the framework, algorithms are developed as Java classes derived from the framework's Algorithm class. The framework 210B maps protocol event messages into function calls on the Algorithm class and provides functions that map into protocol messages to update an order. Table 1 below exemplarily lists Java classes derived from the framework's Algorithm class.

TABLE 1
Class Summary

| | |
|---|---|
| Algorithm | Abstract class that all algorithms must extend. |
| AlgorithmOrder | Details of an order being traded by an algorithm. |
| AmendRequestEvent | An amendment request for an order being |
| | processed by an algorithm. |
| DateTimeFormat | Class for formatting and parsing FIDESSA |
| | daytime strings into Java Date objects. |
| Framework | Entry point for the algorithm framework. |
| MarketDataEvent | A market data event. |
| Order | Details of an order. |
| Slice Order | Details of a slice order being created by an |
| | algorithm. |

Enum Summary

| | |
|---|---|
| Algorithm.State | |
| Order.ExpiryType | Order expiry types supported by the framework. |
| Order.OrderType | Order types supported by the framework. |

Exception Summary

| | |
|---|---|
| ActionFailedException | Exceptions thrown by Algorithm class when |
| | action fails. |
| AlgorithmException | Base class for all exceptions thrown by |
| | an algorithm. |

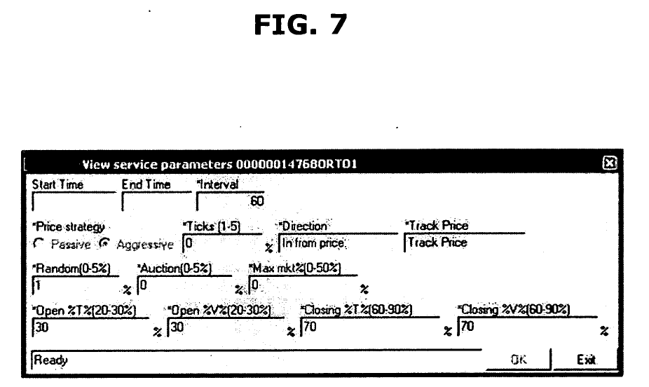

Further, as shown in FIG. 7, associated with the algorithm is a dialog configuration file which is exemplarily written in XML and displayed to the user via an order management dialogue 110A. The configuration file controls how the algorithm-specific parameters are presented to the user when an order is routed or split to the algorithm. Parameters that may be set by the configuration file includes text, quantity, percentage, date, time, radio and drop down options.

In addition to developing an implementation of the Algorithm class in Java, the framework 210B requires the algorithm developer to provide an algorithm descriptor file. The descriptor file names the algorithm, specifies the Java class file that implements the algorithm, and provides the dialog configuration file.

### Deploying Algorithms

The framework 210B loads algorithms when it starts; it then communicates with the AOM manager 210A as to what algorithms the framework 210B has loaded. The framework 210B looks for descriptor files, class files and dialog configuration files in user-defined locations. In order to deploy an algorithm, it is advantageous for the algorithm's descriptor, class file and dialog configuration file to be copied into the user-defined locations.

As shown above with respect to the exemplary embodiments of FIGS. 2 and 3, the AOM framework 210B may run either inside or outside the existing trading platform. If more than one framework offers the same algorithm, then orders routed or split to that algorithm are allocated to each framework in a round-robin fashion.

The AOM manager 210A of the exemplary embodiment provides a configuration file that lists the frameworks that can connect to it. The list contains the unique framework ID and the hostname the framework runs on. When a framework logs on to the AOM Manager 210A, it must supply the framework ID and the hostname. If the framework ID and hostname are not in the list of allowed frameworks, the logon is rejected.

### Testing Algorithms

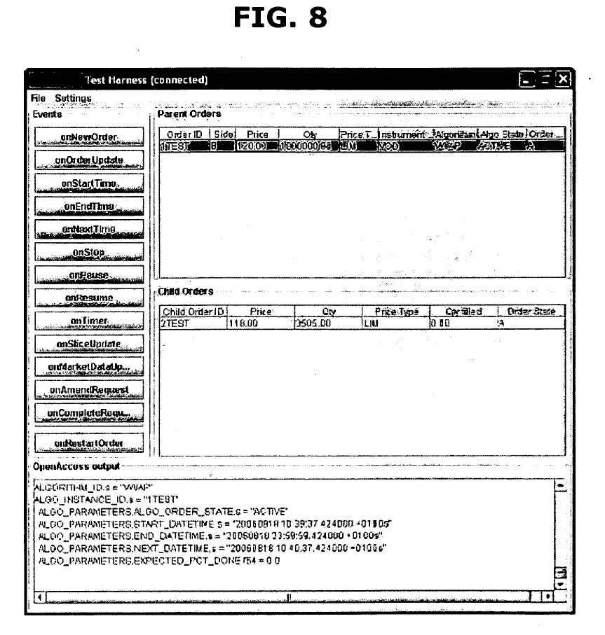

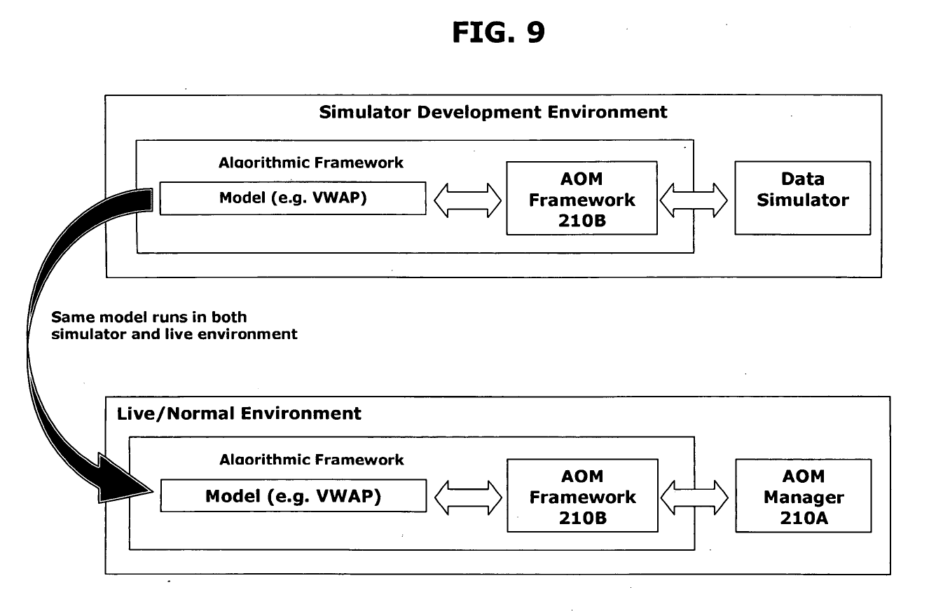

According to an exemplary embodiment, a test harness which is exemplarily written in Java that allows algorithm developers to unit-test their code (or in general their models) without connecting to the order management system or services that do the actual trading. FIG. 8 is an exemplary illustration of a test harness utilized in the exemplary embodiment. The test harness communicates with an algorithm using the algorithm manager protocol. This allows the test harness to be used to test algorithms written directly against the OpenAccess API, as well as algorithms written through the Java framework 201. As shown in FIG. 8, the test harness is a graphical user interface (GUI) application that allows a user to emulate events within the AOM tool of the present invention and send them to an algorithm. The user can then inspect the messages received back from the algorithm and generate replies back to the algorithm. FIG. 9 is an exemplary illustration of a simulator development environment within the testing models according to an exemplary embodiment of the present invention. As can be seen from FIG. 8, the data simulator provides for a simulated version of the AOM manager 210A.

### Algorithmic Order Maintenance

The AOM tool 210 provides a set of algorithmic order maintenance functions that operate at the order level. Such algorithmic order maintenance functions are typically available from the standard order management system of the existing trading platform which the AOM tool 210 is integrated into. Orders routed to an algorithm are owned by the AOM tool. 210 As such, the AOM tool 210 is responsible for accepting or rejecting orders routed to an algorithm and releasing orders when algorithmic trading has ended. The AOM tool 210 is also responsible for accepting or rejecting amendments and cancellations for orders routed to an algorithm. The decision whether to accept or reject a new order, amendment or cancellation is not made by the AOM too 2101. Rather, such decisions are made by the algorithm trading the order.

Orders assigned to the AOM tool 210 have an algorithmic order state which indicates the current status of the algorithm trading the order. Some of the algorithmic order states are exemplarily listed in Table 2.

TABLE 2

| State | State Status |
|---|---|
| Sleeping | The algorithm is active but is waiting for the start time. |
| Active | The algorithm is actively trading the market |
| Paused | The algorithm has been paused by the user |
| Ended | The algorithm has stopped processing and will not start again |
| Error | The algorithm has stopped processing and will not start again |
| | because of a code or data error |

Algorithmic orders routed to an algorithm can be amended at any time using the standard order amendment dialog provided by the existing order management system. The parameter amendment dialog can be used to amend the algorithmic-specific parameters for an order. The layout of this dialog is determined by the dialog configuration file for the algorithm.

### Algorithmic Order Monitoring

Orders assigned to the AOM tool 210 may be monitored from the user screen of the client 100, as shown in FIG. 4. The orders may be monitored as well from any standard order management system order grid provided by the existing order management system.

The AOM tool 210 provides new fields, available from standard order management system order grids, to show the state of an order being traded by an algorithm. Not all fields apply to all algorithms. If an order is being traded by an algorithm to which a certain field does not apply that field is left blank. Table 4 exemplarily lists the various fields within the trader's user screen.

TABLE 3

| Order Fields | Significance |
|---|---|
| State | The current state of the algorithm trading the order |
| Start at | The time algorithmic trading started or will start |
| End at | The time algorithmic trading stopped or will stop |
| Next at | The time the next child order will be sent to the market |
| Time left | The number of seconds before the most recent child |
| | order will expire |
| Ticks away | The number of price ticks between the price of the most |
| | recent child order and the price at which the |
| | order would be executable |
| Number | The number of uncompleted child orders. |
| of active | |
| slices | |

The trader's user screen 100 of FIG. 4 provides a convenient way to monitor algorithmic orders. The trader's user screen 100 displays a user's orders filtered to show only those assigned to the AOM tool 210.

While the present invention has been particularly shown and described with reference to exemplary embodiments and illustrations thereof, it will be understood by those of ordinary skill in the art that various changes in forms and details may be made therein without departing from the spirit and scope of the present invention as defined by the following claims.

What is claimed is:

1. A method of building and deploying trading algorithms which are used for automated algorithmic handling of orders of financial instruments in electronic marketplaces, the method comprising:
developing trading algorithms driven by a plurality of parameters in an algorithmic model framework using a higher level application programming interface;
calling the trading algorithms developed in the algorithmic model framework into an order management system through an algorithm manager protocol including a lower level application programming interface; and
associating the trading algorithms with an order for the automated algorithmic order handling.

2. The method of claim 1, wherein the algorithmic model framework utilizes an object oriented programming language to develop the trading algorithms.

3. The method of claim 2, wherein the higher level application program interface is a JAVA interface.

4. The method of claim 1, wherein the calling the trading algorithms into the order management system is handled by an algorithm manager.

5. The method of claim 4, wherein the algorithm manager is integrated within an existing trading platform which houses the order management system.

6. The method of claim 4, wherein the calling the trading algorithms into the order management system is initiated by a user command from a user terminal.

7. The method of claim 6, further comprising modifying values of the plurality of parameters using the user terminal.

8. The method of claim 7, further comprising controlling the automated algorithmic order handling using the user terminal.

9. An apparatus which builds and deploys trading algorithms which are used for automated algorithmic handling of orders of financial instruments in electronic marketplaces, the apparatus comprising:
at least one algorithmic model framework which develops the trading algorithms;
an algorithm manager which calls for the trading algorithms into an order management system of an existing trading platform;
a user terminal which provides user commands to perform the automated algorithmic execution of orders.

10. The apparatus of claim 9, wherein the algorithm manager supports a plurality of algorithmic model frameworks.

11. The apparatus of claim 10, wherein the algorithmic model frameworks develop the trading algorithms using a higher level application programming interface; and the algorithm manager calls the trading algorithms developed in the algorithmic model framework through an protocol including a lower level application programming interface.

12. The apparatus of claim 11, wherein the algorithmic model frameworks utilize an object oriented programming language to develop the trading algorithms.

13. The apparatus of claim 12, wherein the higher level application program interface is a JAVA interface.

14. The apparatus of claim 11, wherein the algorithm manager is integrated within an existing trading platform which houses the order management system.

15. The apparatus of claim 11, further comprising a user terminal, wherein the calling the trading algorithms into the order management system is initiated by a user command from the user terminal.

16. The apparatus of claim 15, wherein values of parameters of the trading algorithms are modified using the user terminal.

17. The apparatus of claim 16, wherein automated algorithmic handling of orders is controlled using the user terminal.

18. The apparatus of claim 11, further comprising a data simulator that provides a simulated version of the algorithm manager.

19. The apparatus of claim 18, wherein the data simulator calls for the trading algorithms using a same algorithm manager protocol that is used for communication between the algorithm manager and the plurality of algorithmic model frameworks.
